(19) United States
(12) Patent Application Publication
(10) Pub. No.: US 2011/0058713 A1
(43) Pub. Date: Mar. 10, 2011

(54) DIGITAL PHOTO FRAME, CONTROL METHOD AND RECORDING MEDIUM WITH CONTROL PROGRAM

(75) Inventors: Takayuki KOGANE, Tokyo (JP); Sumito SHINOHARA, Tokyo (JP); Masato NUNOKAWA, Tokyo (JP); Tetsuya HANDA, Tokyo (JP); Kimiyasu MIZUNO, Tokyo (JP); Takehiro AIBARA, Tokyo (JP); Hitoshi AMAGAI, Tokyo (JP); Naotaka UEHARA, Tokyo (JP)

(73) Assignee: Casio Computer Co., Ltd., Tokyo (JP)

(21) Appl. No.: 12/872,378

(22) Filed: Aug. 31, 2010

(30) Foreign Application Priority Data
Sep. 4, 2009 (JP) 2009-204387

(51) Int. Cl. G06K 9/46; G06T 7/00

(52) U.S. Cl. 382/118; 382/190; 382/100

(57) ABSTRACT

A digital photo frame including a display section capable of sequentially displaying at least two digital photographs judges the facial expression of a person viewing a digital photograph displayed in the display section, and information related to this judged facial expression is stored in association with the digital photograph being displayed. Also, when stored digital photographs are to be displayed, information related to a facial expression stored in association with each digital photograph and a judged facial expression of a person are compared, and the display of each stored digital photograph is controlled based on the comparison result.

### CROSS-REFERENCE TO RELATED APPLICATION

This application is based upon and claims the benefit of priority from the prior Japanese Patent Application No. 2009-204387, filed Sep. 4, 2009, the entire contents of which is incorporated herein by reference.

### BACKGROUND OF THE INVENTION

1. Field of the Invention

The present invention relates to a digital photo frame, a control method and a recording medium with a control program.

2. Description of the Related Art

Photographs captured by digital cameras are stored as digital format image files (hereinafter referred to as “digital photograph” or simply “photograph”). Therefore, these photographs have an advantage in that they are not necessarily required to be outputted and printed on paper, and can be displayed as images (can be displayed on the monitor of a personal computer) whenever desired. However, it is undeniable that these photographs are inconvenient for a person unfamiliar with personal computers.

In response to this, a convenient display device referred to as a digital photo frame (DPF) is now being used. The DPF is a device that even a person unfamiliar with personal computers can use easily, which allows a digital photograph recorded on a recording medium to be automatically displayed simply by the recording medium being removed from a digital camera and set in the DPF.

However, the DPF merely reads out and displays digital photographs recorded in the set recording medium in order or at random, and therefore is disadvantageous in that photographs not suited to the viewer's preference are displayed.

A technology regarding a DPF that includes a camera is disclosed in Japanese Patent Application Laid-Open (Kokai) Publication No. 2008-165009 and Japanese Patent Application Laid-Open (Kokai) Publication No. 2009-171176. In Japanese Patent Application Laid-Open (Kokai) Publication No. 2008-165009, the display priority of a photograph is determined based on the number of times a photograph being displayed is viewed (recognized) and the length of time the photograph is viewed. Also, in Japanese Patent Application Laid-Open (Kokai) Publication No. 2009-171176, the favorite photographs of each registered user are displayed for each registered user.

However, in the technology disclosed in Japanese Patent Application Laid-Open (Kokai) Publication No. 2008-165009, photographs are displayed based at least on an order of priority determined in advance. Therefore, it is possible that a photograph that does not match the current emotion of the viewer is displayed. This is disadvantageous because, for example, if a sad photograph is displayed when the viewer is in a happy mood, the viewer is depressed thereby.

Also, the technology disclosed in Japanese Patent Application Laid-Open (Kokai) Publication No. 2009-171176 is disadvantageous in that favorite photographs are required to be selected in advance for each registered user, which is troublesome and inconvenient.

When the range of researching conventional technologies is expanded outside the DPF, for example, the following technologies are found.

In U.S. Pat. No. 7,636,456, a display device is disclosed which is capable of displaying an optimal advertisement image for each person viewing an advertisement image. In this device, the facial expression of a person viewing the advertisement image is captured with a camera, and when the facial expression indicates “boredom”, a predetermined image is displayed to recapture the person's attention.

Also, in Japanese Patent Application Laid-Open (Kokai) Publication No. 2006-251271, a karaoke system is described which delivers the voice (singing voice) of a singer and an animation image of the person to the listener side. In this system, the facial expression of a singer is captured by a camera and reflected in an animation image.

Furthermore, in Japanese Patent Application Laid-Open (Kokai) Publication No. 2008-118527, a technology is described in which an image equivalent to the field of view of a user is shot and stored, and biological information (pulse, heart rate, electrocardiogram, and the like) of the user at the time the image is stored is detected and stored in association with the image. When the user attempts to view an image, the biological information of the user is again detected, and the image with which the same biological information is associated is read out and displayed.

However, the above-described technologies have the following problems:

(1) U.S. Pat. No. 7,636,456

A predetermined video is merely played when the facial expression of a person viewing the image indicates “boredom”. In other words, the display device is merely designed to recapture attention.

(2) Japanese Patent Application Laid-Open (Kokai) Publication No. 2006-251271

The facial expression of a singer is merely reflected in an animation image.

(3) Japanese Patent Application Laid-Open (Kokai) Publication No. 2008-118527

Although the selective display of an image is performed based on biological information, this biological information is pulse, heart rate, electrocardiogram, etc., and not the facial expression of a person viewing the image.

Therefore, when considering the applicability of these technologies in the DPF, (2) is unsuitable for application to the DPF because it is an animation technology for karaoke. Regarding (1), how to select a video to recapture a person's attention is unclear (According to the descriptions of U.S. Pat. No. 7,636,456, a video of an action/adventure movie is played when the viewer becomes bored. However, an action/adventure movie does not always recapture a person's attention. There are people who are not interested in such videos).

Regarding (3), there is a problem in that an elaborate apparatus is required to detect biological information such as pulse, heart rate, electrocardiogram, and the like, which is costly and impractical.

### SUMMARY OF THE INVENTION

The present invention has been conceived to solve the above-described problems. An object of the present invention is to provide a digital photo frame capable of easily displaying a photograph corresponding to a current emotion with a simple mechanism, a control method thereof and a recording medium with a control program thereof.

In order to achieve the above-described object, in accordance with one aspect of the present invention, there is provided a digital photo frame including a display section capable of sequentially displaying at least two digital photographs, comprising: a facial expression judgment means for judging a facial expression of a person viewing a digital photograph displayed in the display section; and an association storage means for storing information related to the facial expression judged by the facial expression judgment means in association with the digital photograph being displayed.

In accordance with another aspect of the present invention, there is provided a digital photo frame including a display section capable of sequentially displaying at least two digital photographs, comprising: a facial expression judgment means for judging a facial expression of a person gazing towards the display section when any of the at least two digital photographs is to be displayed in the display section; an association judgment means for judging whether or not information corresponding to information related to the facial expression judged by the facial expression judgment means has been associated with a digital photograph to be displayed; and a display permitting means for permitting display of the digital photograph in the display section when a judgment result made by the association judgment means is affirmative.

In accordance with another aspect of the present invention, there is provided a method for controlling a digital photo frame including a display section capable of sequentially displaying at least two digital photographs, comprising: a facial expression judgment step of judging a facial expression of a person viewing a digital photograph displayed in the display section; and an association storage step of storing information related to the facial expression judged in the facial expression judgment step in association with the digital photograph being displayed.

In accordance with another aspect of the present invention, there is provided a method for controlling a digital photo frame including a display section capable of sequentially displaying at least two digital photographs, comprising: a facial expression judgment step of judging a facial expression of a person gazing towards the display section when any of the at least two digital photographs is to be displayed in the display section; an association judgment step of judging whether or not information corresponding to information related to the facial expression judged in the facial expression judgment step has been associated with a digital photograph to be displayed; and a display permitting step of permitting display of the digital photograph in the display section when a judgment result made in the association judgment step is affirmative.

In accordance with another aspect of the present invention, there is provided a non-transitory computer-readable recording medium having stored thereon a program that is executable by a computer in a digital photo frame including a display section capable of sequentially displaying at least two digital photographs, the program being executable by the computer to perform a process comprising: facial expression judgment processing for judging a facial expression of a person viewing a digital photograph displayed in the display section; and association storage processing for storing information related to the facial expression judged in the expression judgment processing in association with the digital photograph being displayed.

In accordance with another aspect of the present invention, there is provided a non-transitory computer-readable recording medium having stored thereon a program that is executable by a computer in a digital photo frame including a display section capable of sequentially displaying at least two digital photographs, the program being executable by the computer to perform a process comprising: facial expression judgment processing for judging a facial expression of a person gazing towards the display section when any of the at least two digital photographs is to be displayed in the display section; association judgment processing for judging whether or not information corresponding to information related to the facial expression judged in the facial expression judgment processing has been associated with a digital photograph to be displayed; and display permitting processing for permitting display of the digital photograph in the display section when a judgment result made in the association judgment processing is affirmative.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A and FIG. 1B are appearance diagrams of a digital photo frame (DPF) according to an embodiment;

FIG. 2 is an internal block diagram of a DPF 1;

FIG. 3 is a conceptual structural diagram of a photograph list table used by an added function;

FIG. 4 is a diagram showing a control program run by a CPU 20 of a controlling section 19;

FIG. 5 is a diagram showing categorization processing (Step S6 in FIG. 4);

FIG. 6 is a conceptual diagram of categorization;

FIG. 7A to FIG. 7C are conceptual diagrams of selective display in accordance with category classification;

FIG. 8A and FIG. 8B are diagrams of a modified structure of a photograph list table 27 of the embodiment and the structure of a viewer registration data table;

FIG. 9 is a diagram showing a modified example of the main flow (see FIG. 4) of the embodiment; and

FIG. 10 is a diagram showing a modified example of the categorization processing (see FIG. 5) of the embodiment.

### DETAILED DESCRIPTION OF THE PREFERRED EMBODIMENTS

The present invention will hereinafter be described in detail with reference to the preferred embodiments shown in the accompanying drawings.

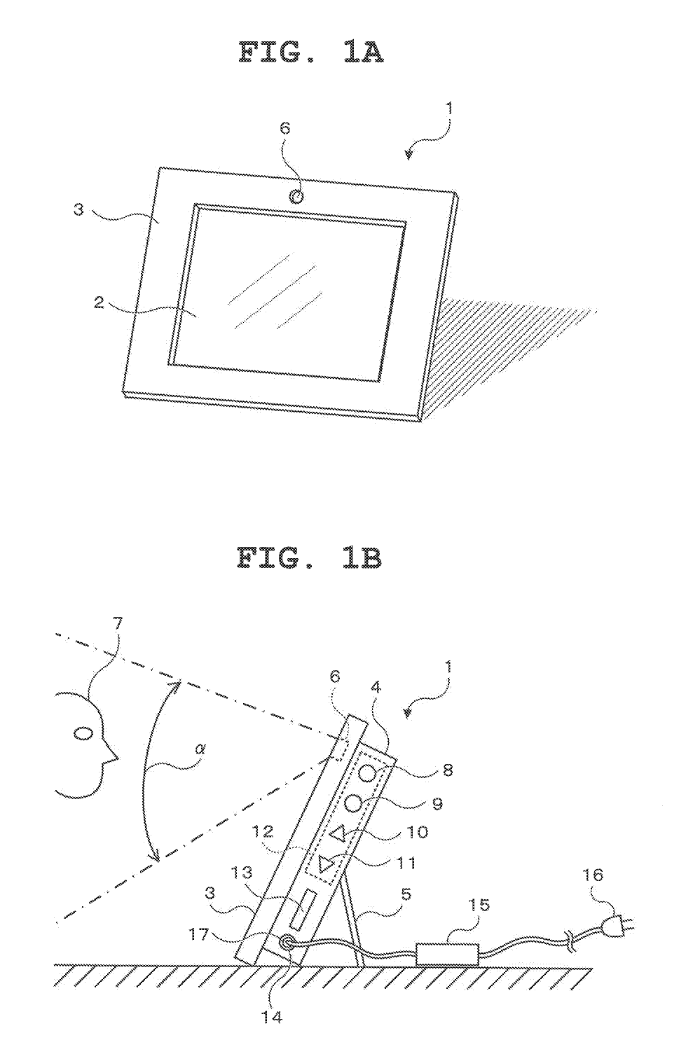

FIG. 1A and FIG. 1B are appearance diagrams of a digital photo frame (DPF) according to an embodiment. In the drawings, a DPF 1 includes a display section 2, a frame 3, an electronic circuit housing box 4, and a collapsible leg section 5. The DPF 1 also includes a camera 6 (imaging means) . The display section includes a display-information-rewritable-type display device, such as a liquid crystal panel, an electroluminescent (EL) panel, a plasma panel, and an electronic paper. The frame 3 surrounds the periphery of the display section 2 and is designed accordingly. The electronic circuit housing box 4 is provided on the back surface of the frame 3, and the leg section 5 is mounted on the back surface of this electronic circuit housing box 4. The camera 6 is mounted on an arbitrary position on the front surface side of the frame 3 (above the display section 2 in the drawings).

Here, the shooting angle a of the camera 6 is set to a suitable value allowing the face of a person (referred to, hereinafter, as a viewer 7) viewing a photograph displayed in the display section 2 of the DPF 1 to be captured. In addition, the focal distance of the camera 6 is also suitably set based on the distance to the viewer 7.

An operating section 12, a media slot 13, and a power supply connector 14 are provided on a side surface of the electronic circuit housing box 4. The operating section 12 includes various switches, such as a power switch 8, a menu switch 9, an upward-arrow switch 10, and a downward-arrow switch 11, and the media slot 13 is provided to insert a recording medium, such as a card-type memory device (a Compact Flash [CF] card, a Secure Digital [SD] card, and the like), a detachable hard disk, or a magnetic disk. When using the DPF 1, the user inserts an alternating-current (AC) plug 16 of an AC adapter 15 into an outlet on a wall surface (not shown), and after inserting a power supply plug 17 of the AC adapter 15 into the power supply connector 14 on the side surface of the electronic circuit housing box 4, turn ON the power switch 8.

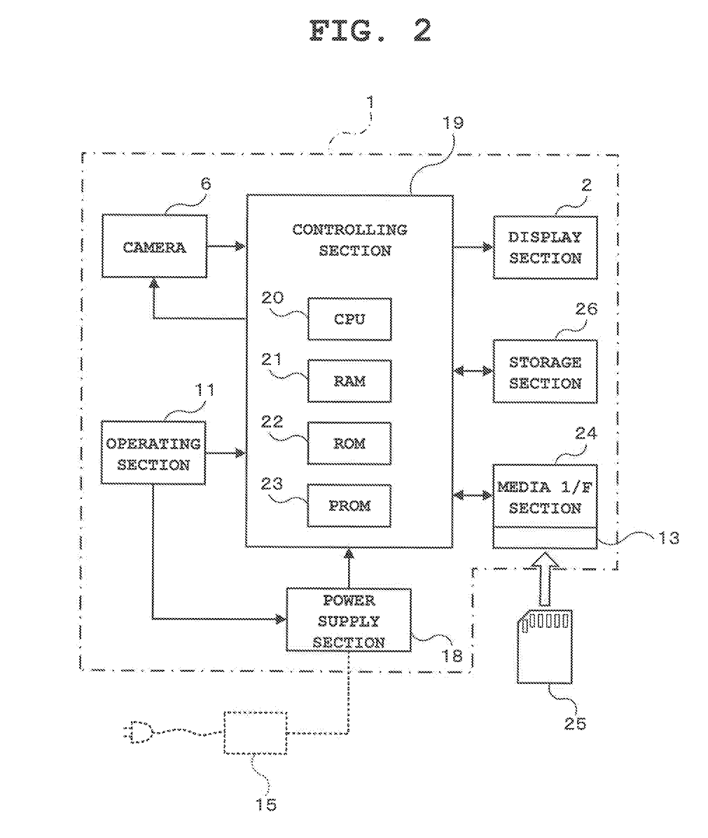

FIG. 2 is an internal block diagram of the DPF 1. In FIG. 2, a power supply section 18 receives a direct-current (DC) power supply from the AC adapter 15 and generates various power supply voltages required to operate the DPF 1.

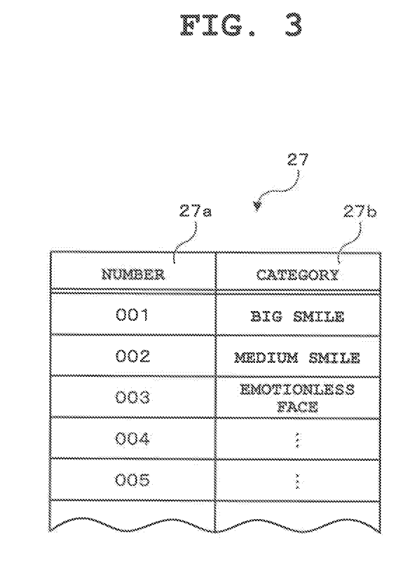

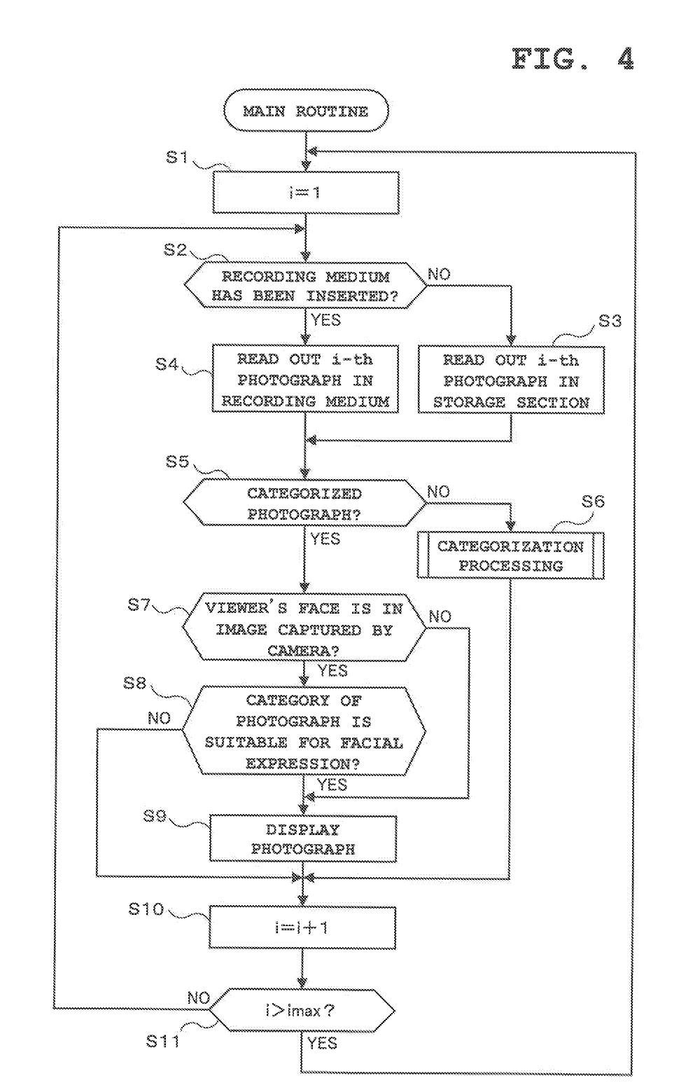

A controlling section 19 is constituted by a so-called microcomputer (or simply a computer) including a central processing unit (CPU) 20, a random access memory (RAM) (volatile high-speed memory) 21, a read-only memory (ROM) (non-volatile memory) 22, a programmable read-only memory (PROM) (rewritable non-volatile memory) 23, and other peripheral circuits. A control program (see FIG. 4 described hereafter) written in the ROM 22 in advance and variable data (see FIG. 3 described hereafter) written accordingly in the PROM 23 are loaded into the RAM 21, and the CPU 20 runs this control program, whereby functions required for a DPF (in other words, functions provided by a facial expression judgment means, an association storage means, a display controlling means, an association judgment means, display permitting means, a person identification information holding means, and a person identification means) are actualized.

Specifically, the controlling section 19 judges whether or not a recording medium 25 has been inserted into the media slot 13 of a media interface (I/F) section 24. Then, when judged that the recording medium 25 has been inserted, the controlling section 19 reads out an image file (referred to, hereinafter, as a “photograph” for convenience) stored in the recording medium 25 and displays it in the display section 2.

Conversely, when judged that the recording medium 25 has not been inserted, the controlling section 19 reads out a photograph stored in a storage section 26 serving as an internal memory (a sample photograph stored at the time of factory shipment or a photograph transferred in advance from the recording medium 25) and displays it in the display section 2. The basic functions of a DPF are actualized in this manner.

Furthermore, according to the embodiment, as described in detail hereafter, a unique function (referred to, hereinafter, as an added function) is actualized in which, when displaying a photograph in the display section 2, the controlling section 19 selects and displays a suitable photograph based on the facial expression of a viewer captured by the camera 6 rather than merely displaying a plurality of photographs in order or at random. The present invention differs from the earlier described conventional technologies in this respect.

FIG. 3 is a conceptual structural diagram of a photograph list table used by the added function. This photograph list table 27 is stored in the PROM 23 of the controlling section 19, and the contents of which is updated (rewritten) as required.

The photograph list table 27 is constituted by a plurality of records of which the number is equivalent to the number of stored photographs. Each record includes a number field 27a for storing an identification number of each photograph (although the identification number is generally a file name, a three-digit numerical sequence is given herein for convenience) and a category field 27b for storing category information of each photograph.

The category information refers to information indicating the facial expression of a viewer in viewing each photograph, and the expressions “big smile”, “medium smile”, and “emotionless face” are used herein for convenience.

Note that these categories (big smile, medium smile, and emotionless face) are merely examples, and the category information is only required to be “information indicating the facial expression of a viewer in viewing each photograph” as described above. Therefore, for example, “small smile” may be added. Alternatively, other facial expressions such as “angry face”, “crying face”, and “sad face” may be added.

Furthermore, these other facial expressions may be further subdivided into, for example, “strong”, “medium”, and “weak”. Alternatively, rather than indicating in stages such as “strong”, “medium”, and “weak”, the level of the facial expression including the above-mentioned smile may be indicated by numerical values. In this case, for example, the strongest level may be indicated by 100, the weakest level may be indicated by 0, and the levels therebetween may be indicated by numerical values within a range of 99 to 1. Alternatively, a smile may be indicated by plus (+), an angry face and a crying face may be indicated by minus (−), and an emotionless face may be indicated by 0.

FIG. 4 is a diagram showing a control program (referred to, hereinafter, as a main routine) run by the CPU 20 of the controlling section 19.

In FIG. 4, when the power switch 8 of the DPF 1 is turned ON, first, the CPU 20 sets a counter variable i used for photograph selection to an initial value “1” (Step S1), and then judges whether or not the recording medium 25 has been inserted into the card slot 13 (Step S2).

When judged that the recording medium 25 has not been inserted, the CPU 20 reads out the i-th photograph stored in the storage section 26 (Step S3) . When judged that the recording medium 25 has been inserted, the CPU 20 reads out the i-th photograph stored in the recording medium 25 (Step S4).

Next, the CPU 20 refers to the photograph list table 27 in the PROM 23 and judges whether or not the i-th photograph has been categorized (Step S5). When judged that the i-th photograph has not been categorized, the CPU 20 performs “categorization processing” described in detail hereafter (Step S6). Conversely, when judged that the i-th photograph has been categorized, the CPU 20 activates the camera 6 and loads a captured image . Then, the CPU 20 judges whether or not the viewer 7's face has been captured in the image (Step S7).

When judged that the viewer 7's face has not been captured, the CPU 20 immediately outputs the i-th photograph in the display section 2 (Step S9). Conversely, when judged that the viewer 7's face has been captured, the CPU 20 judges the facial expression of the viewer 7 (specifically, judges whether the facial expression is a smile, a facial expression other than a smile such as an angry face, a crying face, a sad face, or an emotionless face), and judges whether or not the category of the i-th photograph is suitable for the judgment result (Step S8).

For example, if the number of the i-th photograph is “001”, since the category of the photograph with the number “001” is “big smile” in the photograph list table 27 in this instance, the judgment result at Step S8 is YES when the facial expression of the viewer 7 in the captured image is the same (big smile), and the judgment result at Step S8 is NO when the facial expression of the viewer is a facial expression other than a big smile.

When the judgment result at Step S8 is YES or, in other words, when the category of the i-th photograph is suitable for the facial expression of the viewer 7 captured by the camera 6, the CPU 20 outputs this i-th photograph to the display section 2 to display it (Step S9), and after incrementing the counter variable i by 1 (Step S10), judges whether or not i is greater than imax (imax indicates the total number of photographs) (Step S11).

When judged that i is greater than imax, the CPU 20 returns to Step S1 to perform the endless display of the photographs. When judged that i is not greater than imax, the CPU 20 returns to Step S2 to perform the same processing on the next photograph (the new i-th photograph).

Note that, to judge the facial expression of the viewer 7, a known method may be used that evaluates a facial expression by matching a large number of templates of facial images with a detected facial image.

Alternatively, a known method referred to as “Fisher Linear Discriminant Models” may be used. In this method, a large number of sample images of faces each having two facial expressions are prepared in advance. Then, based on data of the sample images, linear discriminant analysis (LDA) is performed considering a two-class problem between two facial expressions, whereby a discriminant axis that clearly discriminates the two facial expressions is formed in advance. Then, in a facial expression evaluation, a facial expression evaluation value is calculated by a dot product of the inputted facial image data and the discriminant axis being determined. A known method can be used also for the facial detection of the viewer 7.

For example, a known method may be used in which the luminance difference between two pixels within a facial image is learned and stored in advance as a feature quantity, and after a fixed size window being successively applied to an inputted image, whether or not the window includes a face is estimated based on the feature quantity, and an estimation value of facial detection is outputted.

In this method, the same processing is performed by an inputted image being successively reduced, whereby the estimation of facial detection using a fixed size window can be performed, and eventually an area where a face is present can be determined from an estimation value obtained by these operations.

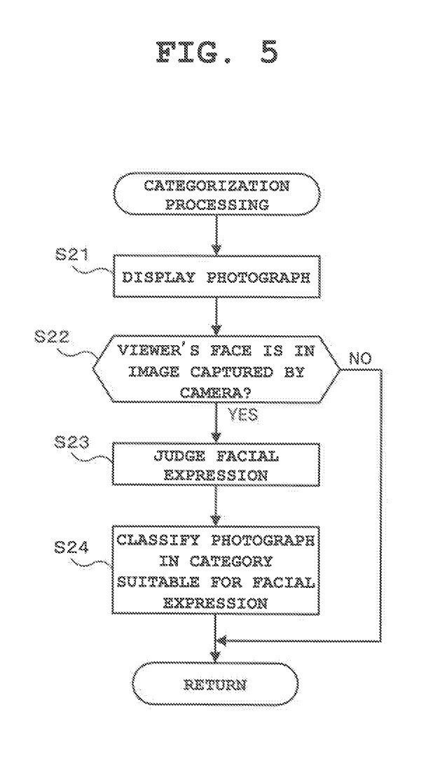

FIG. 5 is a diagram showing the categorization processing (Step S6 in FIG. 4).

In FIG. 5, in the categorization processing, first, the CPU 20 outputs the i-th photograph to the display section 2 and displays it (Step S21). Then, with the i-th photograph being displayed, the CPU 20 actuates the camera 6, and after loading an image captured by the camera 6, judges whether or not the viewer 7's face has been captured in the image (Step S22).

When judged that the viewer 7's face has not been captured, the CPU 20 immediately exits the flow and returns to the main flow in FIG. 4 (proceeds to Step S10). When judged that the viewer 7's face has been captured, the CPU 20 judges the facial expression of the viewer 7 (specifically, judges whether or not the facial expression is a smile, a facial expression other than a smile such as an angry face, a crying face, a sad face, or an emotionless face) (Step S23).

Then, the CPU 20 writes category information corresponding to the judgment result in the category field 27b of the i-th photograph in the photograph list table 27 (Step S24), and exits the flow to return to the main flow in FIG. 4 (proceeds to Step S10).

As just described, in the main flow in FIG. 4 (and the categorization processing in FIG. 5), photographs are successively read from the storage section 26 or the recording medium 25, and if the photographs are judged to have not been categorized, the categorization processing in FIG. 5 is performed, and consequently categorization corresponding to the facial expression of a person viewing the photographs (viewer 7) is performed.

Furthermore, when displaying photographs categorized in this manner, the CPU 20 loads and selectively displays only photographs in a category suitable for the facial expression of the viewer 7 at this time.

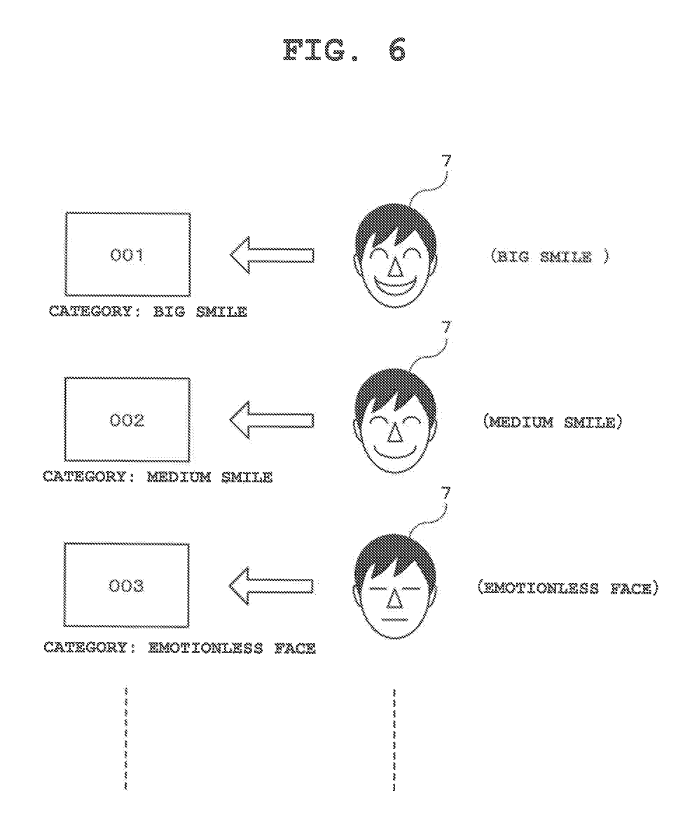

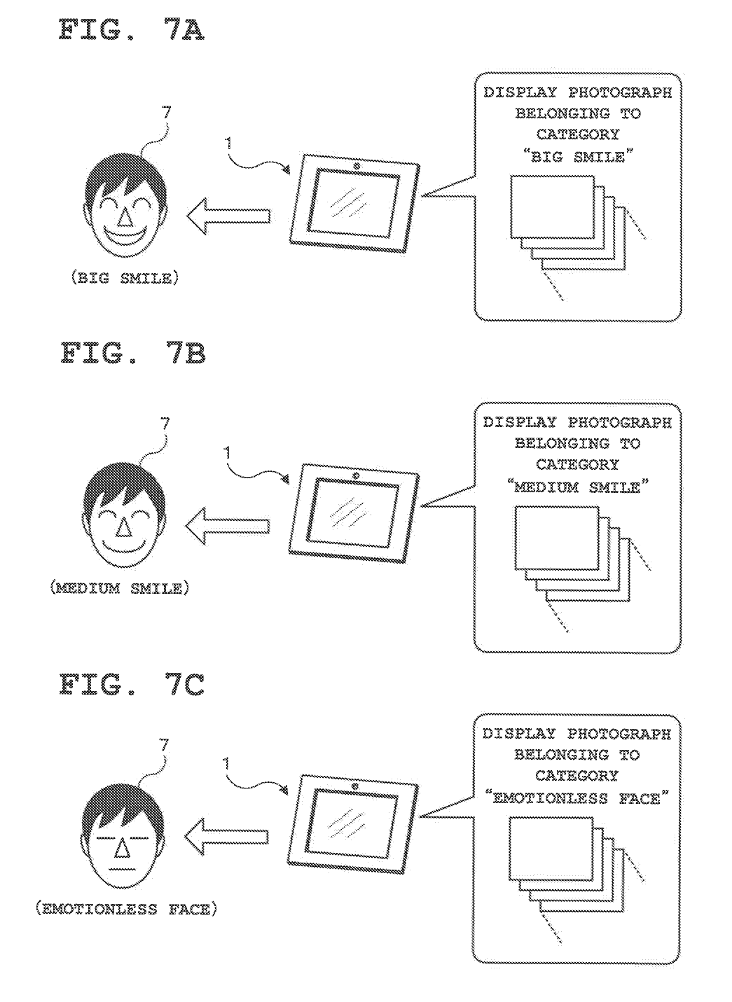

FIG. 6 and FIG. 7A to FIG. 7C are conceptual diagrams showing the operations of the present invention. Specifically, FIG. 6 is a conceptual diagram showing categorization, and FIG. 7A to

FIG. 7C are conceptual diagrams of selective display performed in accordance with category classification.

Here, as shown in FIG. 6, when the facial expression of the viewer 7 who is viewing the photograph numbered “001” is a big smile, “big smile” is written in the category field 27b of the number “001” in the photograph list table 27. Similarly, when the facial expression of the viewer 7 who is viewing the photograph numbered “002” is a medium smile, “medium smile” is written in the category field 27b of the number “002” in the photograph list table 27. Furthermore, when the facial expression of the viewer 7 who is viewing the photograph numbered “003” is an emotionless face, “emotionless face” is written in the category field 27b of the number “003” in the photograph list table 27.

Then, if the facial expression of the viewer 7 is a big smile at the time of viewing these categorized photographs, only photographs in the category “big smile” are displayed in the display section 2 (FIG. 7A) from among photographs stored in the storage section 26 or the recording medium 25.

Alternatively, if the facial expression of the viewer 7 is a medium smile at this time, only photographs in the category “medium smile” are displayed in the display section 2 (FIG. 7B) from among photographs stored in the storage section 26 or the recording medium 25.

Furthermore, if the facial expression of the viewer 7 at this time is an emotionless face, only photographs in the category “emotionless face” are displayed in the display section 2 (FIG. 7C) from among photographs stored in the storage section 26 or the recording medium 25.

As just described, in the embodiment, a photograph suitable for the current emotion (facial expression) of the viewer 7 is selected and displayed. Therefore, the disadvantage in Japanese Laid-Open Patent Publication No. 2008-165009 described earlier can be resolved. Furthermore, since the categorization operation for differentiating emotions is automatically performed when a photograph that has not been categorized is displayed (refer to the categorization processing in FIG. 5), human effort is not required, and therefore the disadvantage in Japanese Laid-Open Patent Publication No. 2009-171176 described earlier can also be resolved.

In addition, since a definite correlation is present, in other words, since the matching of categories is performed between the current emotion of the viewer 7 and photographs to be displayed, the attention of the viewer 7 can be definitely captured compared to the earlier described technique of U.S. Pat. No. 7,636,456 in which a video is played that is unreliable as to whether or not it can recapture the attention of a person feeling boredom. Moreover, an elaborate device for detecting biological information such as pulse, heart rate, and electrocardiogram is not required.

Thus, according to the embodiment, a DPF capable of easily displaying a photograph suitable for a current emotion with a simple mechanism can be actualized.

The above-described embodiment is merely an example embodiment of the present invention, and various modified examples and expanded examples can be conceived within the technical scope of the invention.

For example, the embodiment can be modified to allow differentiation between individual viewers 7.

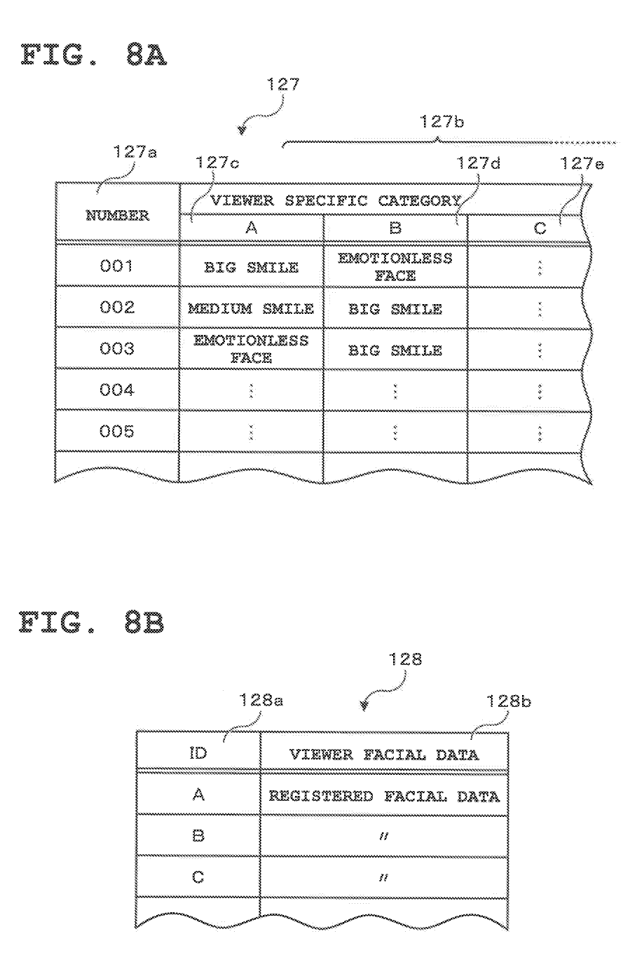

FIG. 8A and FIG. 8B are diagrams showing a modified structure of the photograph list table 27 of the embodiment and the structure of a viewer registration data table.

A photograph list table 127 in FIG. 8A is a modified version of the photograph list table 27 of the embodiment. This photograph list table 127 differs in that a category field is provided for each viewer 7.

That is, the photograph list table 127 includes a number field 127a for storing an identification number of each photograph, and a category field 127b for each viewer 7. The category field 127b for each viewer 7 is further subdivided into a plurality of subcategory fields 127c, 127d, 127e and so on.

Here, in the example in FIG. 8A, the category field 127b is subdivided into three subcategory fields 127c, 127d and 127e for convenience. The subcategory field 127c is for “viewer A”, the subcategory field 127d is for “viewer B”, and the subcategory field 127e is for “viewer C”.

On the other hand, a viewer registration data table 128 is used to register facial data of each viewer A, B, C, and so on in advance. The viewer registration data table 128 includes an identification (ID) field 128a for storing viewer IDs, and a viewer facial data field 128b for storing facial data of each viewer A, B, C, and so on (facial photographs captured by the camera 6 or data indicating facial features).

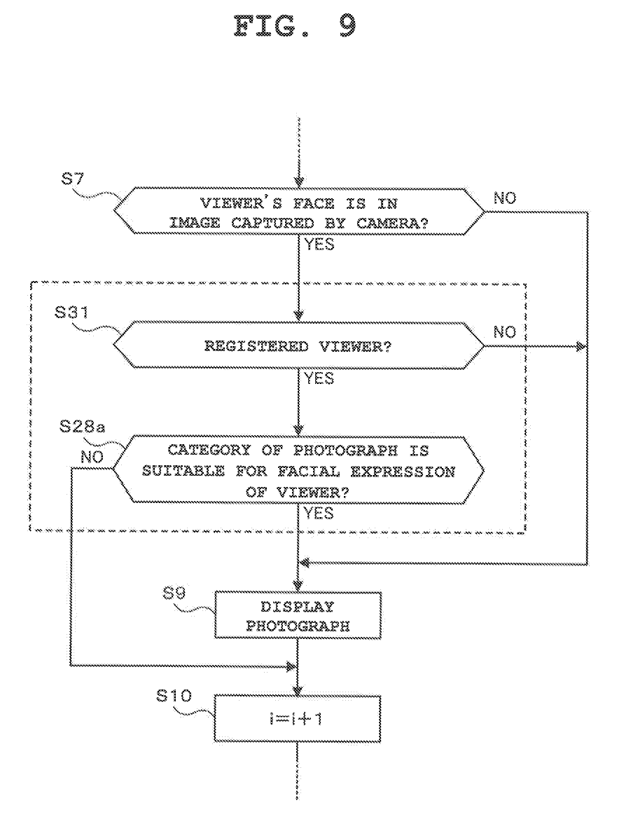

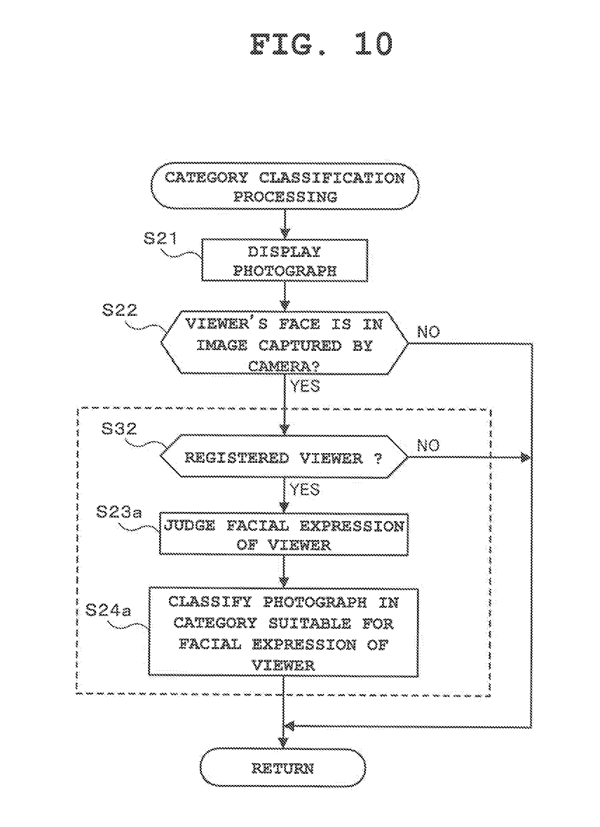

FIG. 9 and FIG. 10 are diagrams showing a modified example of the main flow (see FIG. 4) and a modified example of the categorization processing (see FIG. 5) of the embodiment.

First, as indicated by a dashed enclosing line in FIG. 9, a new Step S31 has been added after Step S7 in the main flow of the embodiment. In addition, a portion of Step S8 in the main flow has been modified, and accordingly Step S8 is referred to as Step S8a.

Specifically, at Step S31, the CPU 20 judges whether or not the viewer 7 being captured by the camera 6 has already been registered to the viewer registration data table 128 (in other words, judges whether or not the viewer 7 is any of viewers A, B, C, and so on). When judged that the viewer 7 has not been registered, the CPU 20 immediately displays the photograph (Step S9). On the other hand, when judged that the viewer 7 has been registered, the CPU 20 proceeds to Step S8a, and refers to the photograph list table 127 to judge whether or not the photograph belongs to a category suitable for the facial expression of the viewer 7.

As indicated by the dashed enclosing line in FIG. 10, a new Step S32 has been added after Step S22 in the categorization processing of the embodiment. In addition, portions of Step S23 and Step S24 in this processing have been modified, and accordingly Step S23 and Step S24 are referred to as Step S23a and Step S24a.

Specifically, at Step S32, the CPU 20 judges whether or not the viewer 7 being shot by the camera 6 has already been registered to the viewer registration data table 128 (in other words, judges whether or not the viewer 7 is any of viewers A, B, C, and so on). When judged that the viewer 7 has not been registered, the CPU 20 immediately returns to the main flow. Conversely, when judged that the viewer 7 has been registered, the CPU 20 identifies the facial expression of the viewer 7 at Step S23a. Then, at Step S24a, the CPU 20 classifies the photograph in the category suitable for the facial expression of the viewer 7.

As a result of these modifications, the selective display of photographs can be performed using categories corresponding to individual viewers A, B, C, and so on, whereby detailed photograph display selection features can be achieved that correspond to the different emotions of each individual towards the photographs.

Accordingly, a universal and more practical DPF is achieved. For example, after each constituent member of a family, a workplace, or the like is registered in advance as the viewer A, B, C, etc. and the categorization of photographs is performed for each person, if any of the constituent members approaches the front of the DPF 1 (views a photograph) , a photograph suitable for the emotion of the viewer at that time can be selectively displayed.

Note that, in the above explanation, the present invention is applied to the DPF. However, this is merely an example, and the invention may be applied to any electronic device capable of displaying a digital photograph (digital image file) . For example, the electronic device may be a digital camera, a digital video camera, an image storage, a gaming machine, a personal computer, or a mobile phone including a display for reproducing images, and other image display devices.

Also note that the display sequence in which photographs are selectively displayed in the embodiment may be in order or at random.

In the case where photographs are displayed in order, the value of the counter variable i for photograph selection and a record number in the photograph list table 27 are associated in pairs. That is, i=1 is the first record, i=2 is the second record, and i=n is the n-th record. Every time the value i is updated, a photograph can be read “in order” from the first record in the photograph list table 27.

In the case where photographs are displayed at random, the value of the counter variable i is updated in an irregular manner . For example, when i=1, i=5, i=3, and so on, the first record, the fifth record, the third record, and so on in the photograph list table 27 are read “out of order” (in other words, at random) .

Additionally, in the embodiment, the categorization processing of a photograph (see FIG. 5) is performed under a condition that the photograph has not been categorized. However, this is not limited thereto. For example, the categorization processing (see FIG. 5) may be performed again for a photograph for which a certain amount of time has elapsed after categorization. This is because an emotion held towards a photograph does not remain the same and may change slightly or significantly depending on the physical condition and living environment of each person, the season, etc.

Moreover, in the above-described modified example of the embodiment (in which viewers are individually distinguished), when an unregistered person is the viewer, the category is disregarded and a photograph is immediately displayed (NO at Step S31 to Step S9 in FIG. 9). However, this is not limited thereto. The invention may be modified to take the category into consideration.

For example, when a person X is an unregistered viewer, and persons a, b, c, and so on are registered viewers (namely viewers A, B, C, and so on registered to the photograph list table 127), categories stored in the photograph list table 127 are suitable for the facial expressions of the persons a, b, c, and so on, but are completely unrelated to the person X.

However, although an emotion held towards a photograph is not shared among all people, in many instances, there is a certain degree of generality (for example, many people who are viewing a delightful photograph uniformly feel delight).

For this reason, even when the unregistered person (person X) is the viewer, the registered categories may be used to selectively display photographs, on the basis that on the idea that emotions uniformly felt by all or a majority of the persons a, b, c, and so on (namely the registered viewers A, B, C and so on) generally apply to the other person X.

When this is performed, even though the selection is not perfect, a photograph in a category generally suitable for the facial expression of the unregistered user (person X) is selectively displayed. Accordingly, compared to when the category is disregarded, this is preferable in that the uniformity of displayed photographs can be increased.

Furthermore, in the embodiment, digital photographs stored in the storage section 26 serving as an internal memory or the removable recording medium 25 are displayed. However, in addition to these photographs, digital photographs stored on a network such as a local area network (LAN) or a wide area network (WAN), or digital photographs transmitted by short-range communication such as infrared communication or Bluetooth communication may be displayed.

Still further, in the embodiment, a photograph in a category matching the facial expression of a viewer is displayed. However, for example, when the face of a viewer is “sad”, a photograph displayed when the viewer is “smiling” may be displayed to cheer up the viewer.

Yet still further, in the embodiment, a person viewing a digital photograph displayed in the display section of the DPF is identified based on an image captured by the camera section provided on the front surface of the DPF. However, even when the DPF is not provided with a camera section, a person viewing a digital photograph displayed in the display section of the DPF, or the presence thereof may be identified based on information inputted from an external source.

Also, this person or the presence thereof may be identified based on speech and the like inputted into a microphone section, instead of an image captured by the camera section. In addition, rather than only detecting the face of a person in an image captured by the camera section, the direction of the gaze may be detected from the detected facial image of the person, and the person may be identified as viewing a digital photograph displayed in the display section of the DPF only when the direction of the gaze is towards the DPF.

Yet still further, in the embodiment, after a digital photograph to be displayed in the display section of the DPF is specified, whether or not to display the digital photograph is determined based on facial expression. However, this digital photograph to be displayed may be selected from among a plurality of digital photographs based on the facial expression of a person viewing digital photographs.

While the present invention has been described with reference to the preferred embodiments, it is intended that the invention be not limited by any of the details of the description therein but includes all the embodiments which fall within the scope of the appended claims.

What is claimed is:

1. A digital photo frame including a display section capable of sequentially displaying at least two digital photographs, comprising:
a facial expression judgment means for judging a facial expression of a person viewing a digital photograph displayed in the display section; and
an association storage means for storing information related to the facial expression judged by the facial expression judgment means in association with the digital photograph being displayed.

2. The digital photo frame according to claim 1, further comprising:
a display controlling means for, when digital photographs stored in the association storage means are to be displayed, comparing information related to a facial expression stored in association with each digital photograph with the facial expression of the person judged by the facial expression judgment means, and controlling display of each digital photograph stored in the association storage means based on a comparison result.

3. The digital photo frame according to claim 2, wherein the display controlling means includes:
an association judgment means for, when any of the at least two digital photographs is to be displayed, judging whether or not information corresponding to the information related to the facial expression judged by the facial expression judgment means has been associated with a digital photograph to be displayed, and
a display permitting means for permitting display of the digital photograph in the display section when a judgment result made by the association judgment means is affirmative.

4. The digital photo frame according to claim 2, wherein the display controlling means selects a digital photograph to be displayed in the display section from among a plurality of digital photographs stored in the association storage means, based on the facial expression of the person judged by the facial expression judgment means.

5. The digital photo frame according to claim 1, wherein the facial expression judgment means identifies, when a digital photograph is being displayed in the display section, a person gazing towards the display section as a person viewing the digital photograph displayed in the display section.

6. The digital photo frame according to claim 1, further comprising:
an imaging means for imaging a subject to acquire an image;
wherein the facial expression judgment means identifies, when a digital photograph is being displayed in the display section, a person detected within the image acquired by the imaging means as a person viewing the digital photograph displayed in the display section, and judges a facial expression of the person by image recognition processing based on the image.

7. The digital photo frame according to claim 1, further comprising:
a person identification information holding means for holding information related to a face of a person; and
a person identification means for identifying the person viewing the digital photograph displayed in the display section based on the information held by the person identification information holding means;
wherein the association storage means stores the information related to the facial expression judged by the facial expression judgment means, in association with the digital photograph being displayed and as information related to the person identified by the person identification means.

8. The digital photo frame according to claim 3, wherein the person identification information holding means arbitrarily registers and holds information related to a face of a person who may possibly view the digital photograph.

9. The digital photo frame according to claim 1, further comprising:
a person identification means for identifying a person gazing towards the display section when any of the at least two digital photographs are to be displayed;
wherein the facial expression judgment means judges a facial expression of the person identified by the person identification means.

10. The digital photo frame according to claim 1, wherein the association storage means associates and stores the information related to the facial expression in a case where the information related to the facial expression has not been stored in association with a digital photograph to be displayed.

11. The digital photo frame according to claim 1, wherein the association storage means associates and stores the information related to the facial expression again even in a case where the information related to the facial expression has already been stored in association with a digital photograph to be displayed, on a condition that a certain amount of time has elapsed from storage of the information.

12. The digital photo frame according to claim 9, wherein the facial expression judgment means judges, when the person gazing towards the display section is not identified based on the information held by the person identification information holding means as a result of identification by the person identification means, the facial expression of the person regardless of the result of the identification by the person identification means; and
the association storage means judges whether or not information corresponding to the information related to the facial expression judged by the facial expression judgment means has been associated with a digital photograph to be displayed.

13. A digital photo frame including a display section capable of sequentially displaying at least two digital photographs, comprising:
a facial expression judgment means for judging a facial expression of a person gazing towards the display section when any of the at least two digital photographs is to be displayed in the display section;
an association judgment means for judging whether or not information corresponding to information related to the facial expression judged by the facial expression judgment means has been associated with a digital photograph to be displayed; and
a display permitting means for permitting display of the digital photograph in the display section when a judgment result made by the association judgment means is affirmative.

14. The digital photo frame according to claim 13, further comprising:
a person identification information holding means for holding information related to a face of a person; and
a person identification means for identifying a person viewing a digital photograph displayed in the display section based on the information held by the person identification information holding means;
wherein the association judgment means judges whether or not the information corresponding to the information related to the facial expression judged by the facial expression judgment means has been associated with the digital photograph to be displayed, as information related to the person identified by the person identification means.

15. A method for controlling a digital photo frame including a display section capable of sequentially displaying at least two digital photographs, comprising:
a facial expression judgment step of judging a facial expression of a person viewing a digital photograph displayed in the display section; and
an association storage step of storing information related to the facial expression judged in the facial expression judgment step in association with the digital photograph being displayed.

16. A method for controlling a digital photo frame including a display section capable of sequentially displaying at least two digital photographs, comprising:
a facial expression judgment step of judging a facial expression of a person gazing towards the display section when any of the at least two digital photographs is to be displayed in the display section;
an association judgment step of judging whether or not information corresponding to information related to the facial expression judged in the facial expression judgment step has been associated with a digital photograph to be displayed; and
a display permitting step of permitting display of the digital photograph in the display section when a judgment result made in the association judgment step is affirmative.

17. A non-transitory computer-readable recording medium having stored thereon a program that is executable by a computer in a digital photo frame including a display section capable of sequentially displaying at least two digital photographs, the program being executable by the computer to perform a process comprising:
facial expression judgment processing for judging a facial expression of a person viewing a digital photograph displayed in the display section; and
association storage processing for storing information related to the facial expression judged in the expression judgment processing in association with the digital photograph being displayed.

18. A non-transitory computer-readable recording medium having stored thereon a program that is executable by a computer in a digital photo frame including a display section capable of sequentially displaying at least two digital photographs, the program being executable by the computer to perform a process comprising:
facial expression judgment processing for judging a facial expression of a person gazing towards the display section when any of the at least two digital photographs is to be displayed in the display section;
association judgment processing for judging whether or not information corresponding to information related to the facial expression judged in the facial expression judgment processing has been associated with a digital photograph to be displayed; and
display permitting processing for permitting display of the digital photograph in the display section when a judgment result made in the association judgment processing is affirmative.
